(19) United States
(12) Patent Application Publication
(10) Pub. No.: US 2015/0321856 A1
(43) Pub. Date: Nov. 12, 2015

(54) CONVEYOR TAKE-UP APPARATUS

(71) Applicant: ALRO Machine Corp., Surrey (CA)

(72) Inventors: Arian DE GOEDE, Mission (CA); Darrell Wayne GILMOUR, Delta (CA)

(21) Appl. No.: 14/707,948

(22) Filed: May 8, 2015

(30) Foreign Application Priority Data
May 9, 2014 (CA) 2851458

(51) Int. Cl. B65G 23/44

(52) U.S. Cl. CPC B65G 23/44

(57) ABSTRACT

A take-up apparatus for adjusting the tension of a conveyor belt is disclosed. The apparatus includes a slider assembly comprising a bearing pedestal for engaging a pulley drive shaft. The slider assembly is configured for sliding movement on an elongated frame positionable alongside a cylinder supporting travel of the conveyor belt. The apparatus includes a push assembly comprising a cylinder support housing for mounting a hydraulic cylinder for applying a force to the slider assembly. The push assembly is movable relative to the frame and can be releasably fixed to the frame at a selected location relative to the slider assembly. This enables use of a relatively short-stroke hydraulic cylinder deployed between the inner and outer ends of the frame irrespective of the travel length required for conveyor belt adjustment. In one embodiment the push assembly may be ratchedly connected to the frame.

### RELATED APPLICATIONS

This application claims priority to Canadian patent application No. 2,851,458 filed 9 May 2014 entitled CONVEYOR TAKE-UP APPARATUS, which is incorporated herein by reference in its entirety.

### TECHNICAL FIELD

The present technology is in the field of hydraulic assist conveyor take-up apparatuses.

### BACKGROUND

A conveyor take-up apparatus is a mechanical device used to adjust the tension of a conveyor belt travelling on a conveyor pulley. A take-up apparatus may be used to initially install a new belt on a pulley cylinder or to adjust the tension of an existing belt. It is important to maintain the belt at the desired tension to ensure that it travels at the same speed as the surface of the driven pulley. The amount of tension required may vary depending upon various factors including the belt material, the mass of the objects being conveyed and the geometry of the conveyor system.

A pair of take-up apparatuses are typically deployed at either end of a pulley shaft at the take-up location. Each apparatus has a bearing pedestal which is coupled to an end of the pulley shaft and is adjustable in position by mean of a rotatable screw. Rotating the screw moves the bearing pedestal and hence the attached pulley cylinder either toward or away from the direction of belt travel, thereby adjusting the tension of the belt. The amount of movement, or length of travel, of the bearing pedestal varies depending upon the particular conveyor application, the length of the conveyor and the tensile rating of the belt.

Hydraulic cylinders are commonly used to assist in assuming at least some of the load of a belt when adjusting the tension thereof. Conventional hydraulic cylinders are mounted at a fixed location at one end of the take-up frame and have a piston rod mechanically coupled to the bearing pedestal. Often such hydraulic cylinders project for a substantial distance beyond the take-up frame which makes the cylinders more vulnerable to damage and raises tripping and other safety risks for conveyor operators working in the vicinity of the pulley cylinders. Also, in some applications, such as subterranean mines, there may not be sufficient room available to accommodate cylinders projecting a long distance from the take-up frame.

Typically belt take-up lengths vary between about 24 and 60 inches, e.g. 24″, 30″, 36″, 48″ and 60″, depending upon the conveyor size and application. Conventional hydraulic assist take-up (HATU) units require a different hydraulic cylinder for each of these discrete take-up lengths. Further, at longer take-up lengths buckling of the piston rod becomes a limiting factor when the cylinder is operated in compression. This problem can be overcome by up-sizing the cylinder rod, but this increases the cost of the overall HATU assembly.

In order to curtail manufacturing costs standard hydraulic cylinders which have a relatively low maximum working pressure, e.g. 3000 psi, are often used. This relatively low working pressure dictates the need for relatively large diameter hydraulic cylinders, especially when the cylinders are operated in tension. As mentioned above, large hydraulic cylinders which project outwardly from take-up frame raise safety and other concerns.

On larger HATU units the manual or electrically driven hydraulic pump units required to extend or retract two hydraulic cylinder piston rods simultaneously (on take-up units deployed at opposite ends of a pulley shaft) become very large, especially in the case of large diameter cylinders requiring a large volume of oil. This can increase operational costs and may not be feasible in some applications having space constraints or where electric power is unavailable. Also, especially on large HATU units, each unit requires its own dedicated, fixed cylinder since the cylinders are typically too heavy to remove and deploy on another unit to perform periodic belt adjustments.

The need has therefore arisen for improved hydraulic assist take-up apparatuses which is more compact and versatile than prior art devices.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

In one embodiment a conveyor take-up apparatus is provided herein comprising an elongated frame positionable adjacent to a pulley cylinder supporting travel of a conveyor belt; a slider assembly configured for travel on the frame, wherein the slider assembly comprises a bearing pedestal for coupling to a shaft of the pulley cylinder; a locking assembly for releasably locking the slider assembly to the frame at an adjustment position; and a push assembly for applying a force to the slider assembly. The push assembly comprises a cylinder support housing movable on the frame and releasably connectable thereto at a selected location along the length of the frame and a hydraulic cylinder mounted on the support housing and having an end coupled to the slider assembly.

The cylinder support housing is adjustable between an engaged position fixably coupled to the frame at the selected location and a disengaged position permitting movement of the support housing relative to the frame. In one embodiment the support housing is ratchedly coupled to the frame in the engaged position. In a particular embodiment, the support housing is adapted for rolling movement on an upper surface of the frame when the support housing is in the disengaged position.

In one embodiment the locking assembly comprises an elongated screw extending lengthwise underneath an upper surface of the frame and having end portions coupled to the frame, wherein the slider assembly comprises an aperture to enable passage of the screw therethrough; and a locking nut rotatably mounted on the screw for locking the slider assembly on the screw at an adjustment position.

In one embodiment a method of adjusting the tension of a conveyor belt travelling on a pulley cylinder having a pulley shaft is provided, the method comprising: (a) providing a take-up apparatus as described herein; (b) coupling the bushing pedestal of the slider assembly to the pulley shaft; (c) engaging the cylinder support housing at a first selected location on the frame; (d) adjusting the locking assembly to an unlocked position; (e) actuating the hydraulic cylinder of the pusher assembly to move the slider assembly on the frame in a direction away from the pusher assembly toward a first end of the frame, thereby tightening the belt; and (f) adjusting said locking assembly to a locked position.

In one embodiment the method may further comprise (f) disengaging the cylinder support housing from the frame and moving the housing toward the first end of the frame to a second selected location on the frame closer to the slider assembly while retracting the cylinder piston; (g) fixedly engaging the support housing on the frame at the second selected position; (h) adjusting the locking assembly to an unlocked position; and (i) actuating the hydraulic cylinder of the pusher assembly to further move the slider assembly on the frame in a direction away from the pusher assembly further toward the first end of the frame, thereby further tightening the belt.

In other embodiments some or all of the sequence steps may be repeated to further tighten the belt, or some or all of the sequence steps may reversed to slacken the belt.

In addition to the exemplary aspects and embodiments described above, further aspects and embodiments will become apparent by reference to the drawings and by study of the following detailed descriptions.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 is a perspective view of a hydraulic assist take-up apparatus representative of the prior art showing the hydraulic cylinder projecting outwardly from the structural frame.

FIG. 2 is a perspective view of an embodiment of the applicant's take-up apparatus showing the hydraulic piston rod extended above the structural frame.

FIG. 3 is a perspective, partially cut-away view showing a pair of the applicant's conveyor take-up apparatuses configured in accordance with the embodiment of FIG. 2 positioned on opposite sides of a pulley shaft during installation of a new belt.

FIG. 4 is a perspective view of the applicant's take-up apparatus of FIG. 2 showing the piston rod in a retracted position.

FIG. 5 is a side elevational view thereof;

FIG. 6 is a top plan view thereof;

FIG. 7 is a bottom plan view thereof;

FIG. 8 is a first end elevational view thereof;

FIG. 9 is a second end elevational view thereof.

FIG. 10 is an exploded, perspective view of the apparatus of FIG. 2.

FIG. 11 is an exploded, enlarged perspective view of an end bracket assembly of the apparatus of FIG. 2.

FIG. 12 is an exploded, enlarged perspective view of the push assembly of the apparatus of FIG. 2.

FIG. 13 is an enlarged, bottom perspective view of the apparatus of FIG. 2 showing the locking nut engaging the slider assembly.

FIG. 14 is an exploded, perspective view of an alternative embodiment of the applicant's take-up apparatus having a castellated ratchet profile.

FIG. 15A-15C are perspective, side elevational and longitudinal sectional views respectively of the apparatus of FIG. 2 during initial installation of a new belt.

FIG. 16A-16C are perspective, side elevational and longitudinal sectional views respectively of the apparatus of FIG. 2 with the hydraulic cylinder piston rod extended to begin tightening the belt and showing the locking nut in a disengaged position.

FIG. 17A-17C are perspective, side elevational and longitudinal sectional views respectively of the apparatus of FIG. 2 with the hydraulic cylinder piston rod extended and showing the locking nut in an engaged position.

FIG. 18A-18C are perspective, side elevational and longitudinal sectional views respectively of the apparatus of FIG. 2 showing the push assembly lifted clear of the ratchet teeth by means of a pivoting handle.

FIGS. 19A-19C are perspective, side elevational and longitudinal sectional views respectively of the apparatus of FIG. 2 showing the hydraulic cylinder piston rod being retracted while the push assembly travels over a top surface of the frame toward the slider assembly.

FIGS. 20A-20C are perspective, side elevational and longitudinal sectional views respectively of the apparatus of FIG. 2 showing the push assembly engaging the ratchet teeth at a location immediately adjacent to the slider assembly.

FIGS. 21A-21C are perspective, side elevational and longitudinal sectional views respectively of the apparatus of FIG. 2 showing the hydraulic cylinder piston rod once again extended to complete a final tightening of the belt and showing the locking nut in a disengaged position

FIG. 22A-22C are perspective, side elevational and longitudinal sectional views respectively of the apparatus of FIG. 2 showing the belt in a fully tightened position and showing the locking nut engaged.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

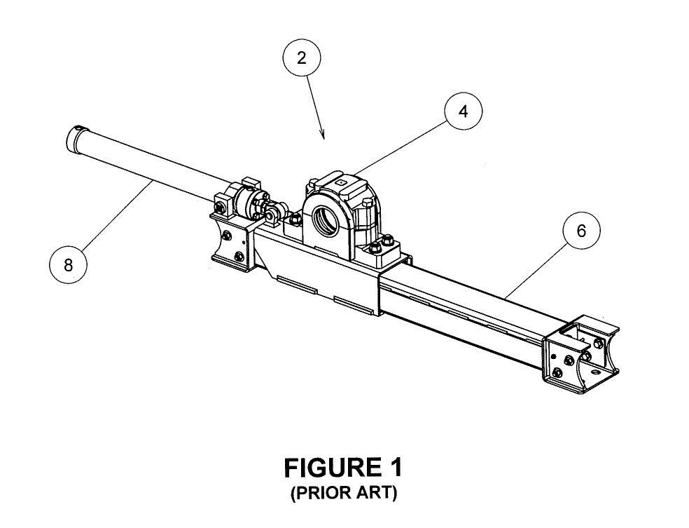

FIG. 1 illustrates a conveyor belt take-up apparatus representative of the prior art generally designated 2 which comprises a bearing pedestal 4 mounted for movement on a structural frame 6. A hydraulic cylinder 8 is coupled to bearing pedestal 4 for actuating movement thereof. Apparatus 2 is configured to operate cylinder 8 in tension to adjust the position of bearing pedestal 4 to tighten a conveyor belt. As illustrated in FIG. 1, cylinder 8 is mounted at a fixed location at one end of frame 6 and projects therefrom to increase the overall length of the unit. As explained above, conventional take-up apparatuses 2 as exemplified by FIG. 1 are vulnerable to damage, raise potential safety risks and exhibit various other limitations as described herein.

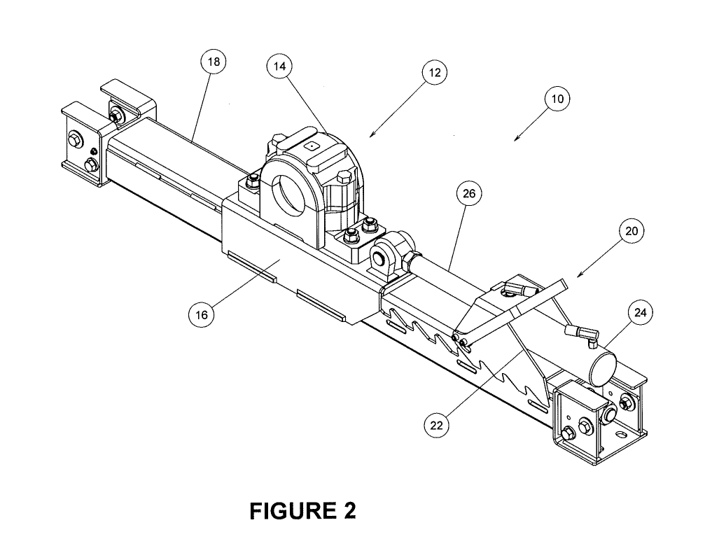

FIG. 2 illustrates an embodiment of the applicant's take-up apparatus generally designated 10. Apparatus 10 includes a slider assembly 12 comprising a bearing pedestal 14 mounted on a slider housing 16. Slider assembly 12 is configured for sliding movement on a structural frame 18. Apparatus 10 also includes a push assembly 20 comprising a cylinder support housing 22 for mounting a hydraulic cylinder 24 having an extendable piston rod 26. As described further below, push assembly 20 is movable relative to frame 18 and can be releasably fixed to frame 18 at a desired adjustment position. Thus, unlike the prior art apparatus of FIG. 1, in the applicant's embodiment of FIG. 2 hydraulic cylinder 24 is not mounted at a fixed end location on frame 18 and does not project outwardly from frame 18 to increase the overall length of the apparatus.

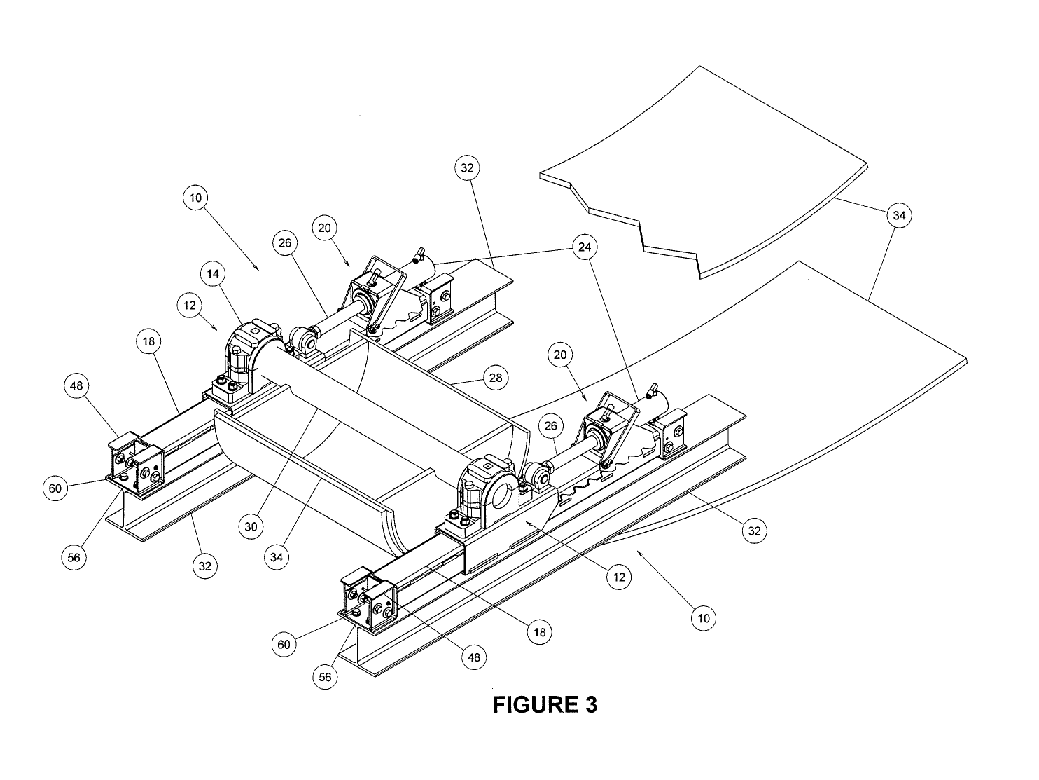

FIG. 3 illustrates a pair of the applicant's conveyor take-up apparatuses 10 configured in accordance with the embodiment of FIG. 2 positioned on opposite sides of a pulley cylinder 28 mounted on a pulley shaft 30 (the upper portion of cylinder 28 and accompanying belt 34 has been cut-away for the purposes of illustration). Frame 18 of each apparatus 10 is mounted on a corresponding structural support 32 extending adjacent pulley cylinder 28. Cylinder 28 and shaft 30 form part of a conveyer system for driving a conveyor belt 34. As described herein, take-up apparatus 10 is adjustable to vary the tension of belt 34 by altering the position of cylinder 28 and shaft 30. In particular, bearing pedestal 14 of slider assembly 12 is coupled to an end portion of pulley shaft 30 and is movable on frame 18 to the desired adjustment location. Moving cylinder shaft 30 in a direction away from the direction of travel of belt 34 pulls belt 34 taut, thus creating tension therein. Conversely, moving cylinder shaft 30 in the direction of travel of belt 34 releases tension and slackens belt 34. Take-up apparatus 10 may be used to adjust the tension of belt 34 either when belt 34 is initially installed or from time to time during operation of the conveyor system. The amount of movement required, or length of travel, varies depending the length and geometry of the conveyor, the load applied to belt 34, the tensile rating of belt 34 and numerous other factors.

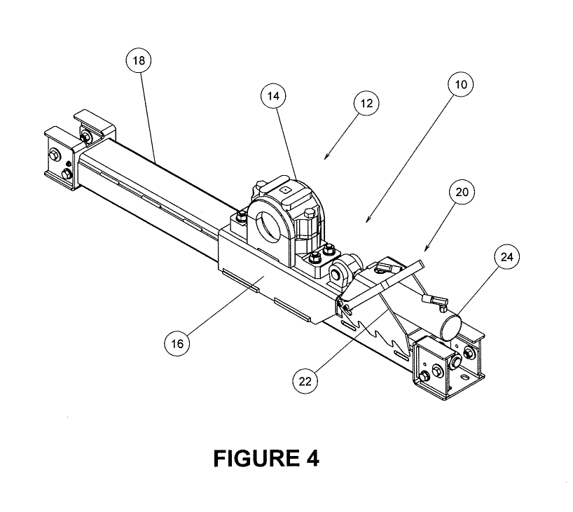

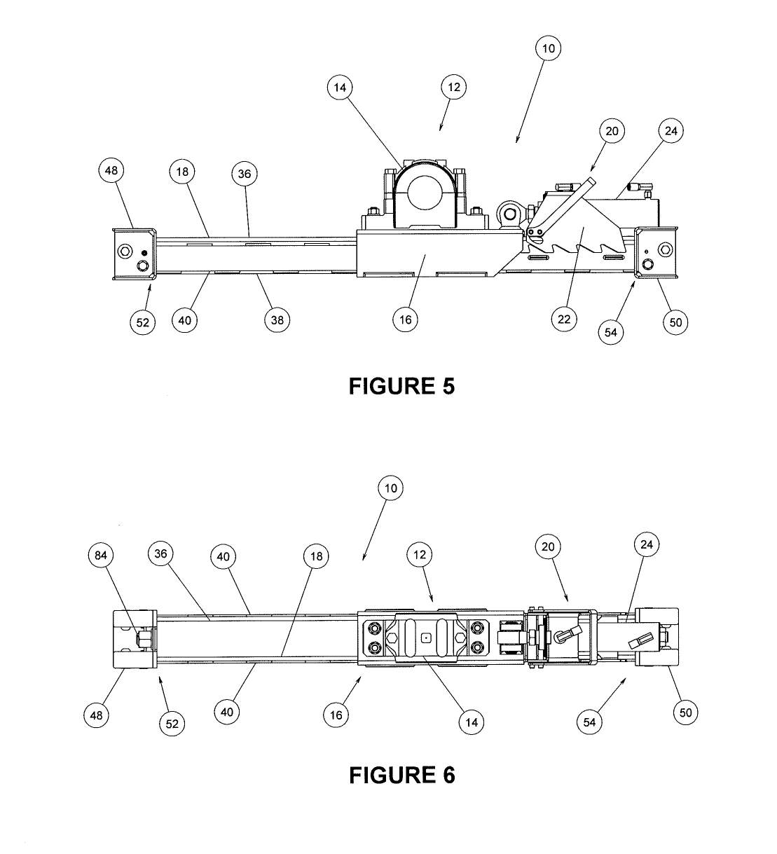

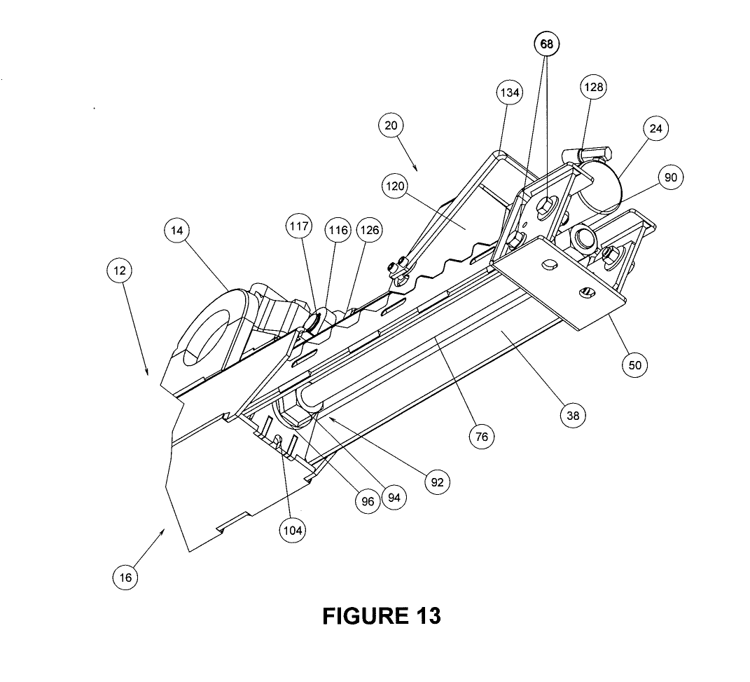

The component parts of the embodiment of take-up apparatus 10 are illustrated in further detail in FIGS. 4-14. Apparatus 10 may be modular for ease of manufacture, assembly and repair of the component parts.

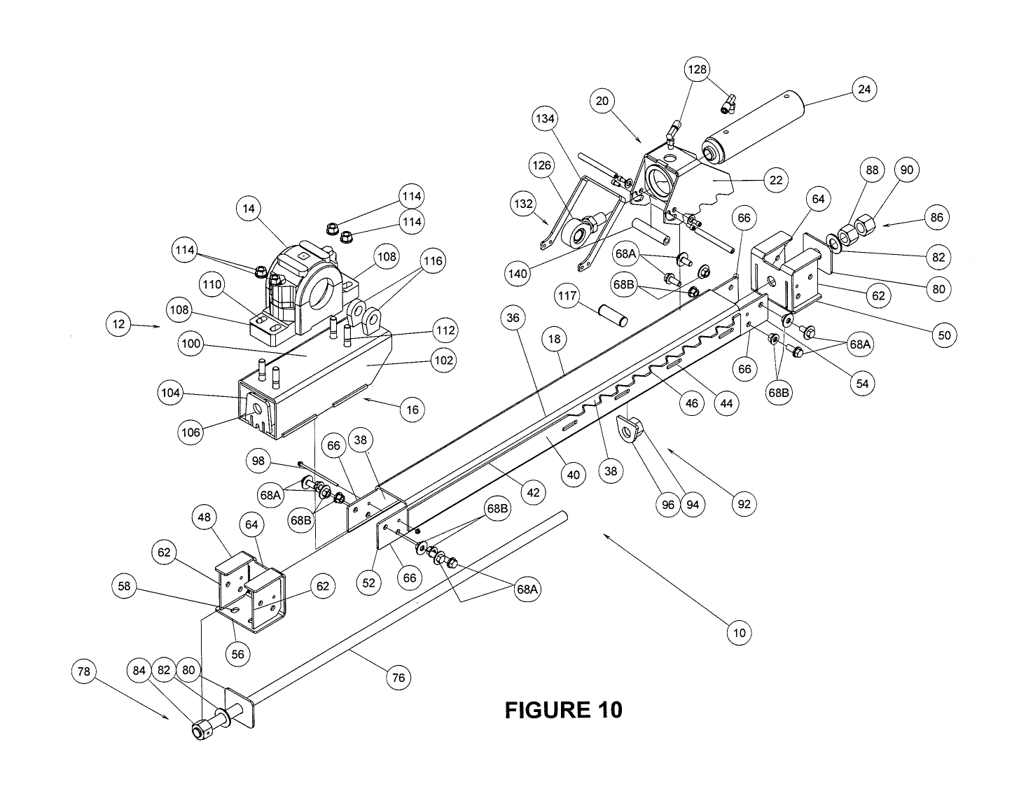

As shown best in the exploded view of FIG. 10, frame 18 has a flat upper surface 36 and opposed side surfaces 38. Side rails 40 are mounted on respective side surfaces 38. For example, side rails 40 may be welded or otherwise integrally formed on side surfaces 38. As explained further below, each side rail 40 has a first portion 42 having a flat upper edge and a second portion 44 having an upper edge formed in a plurality of ratchet grooves 46.

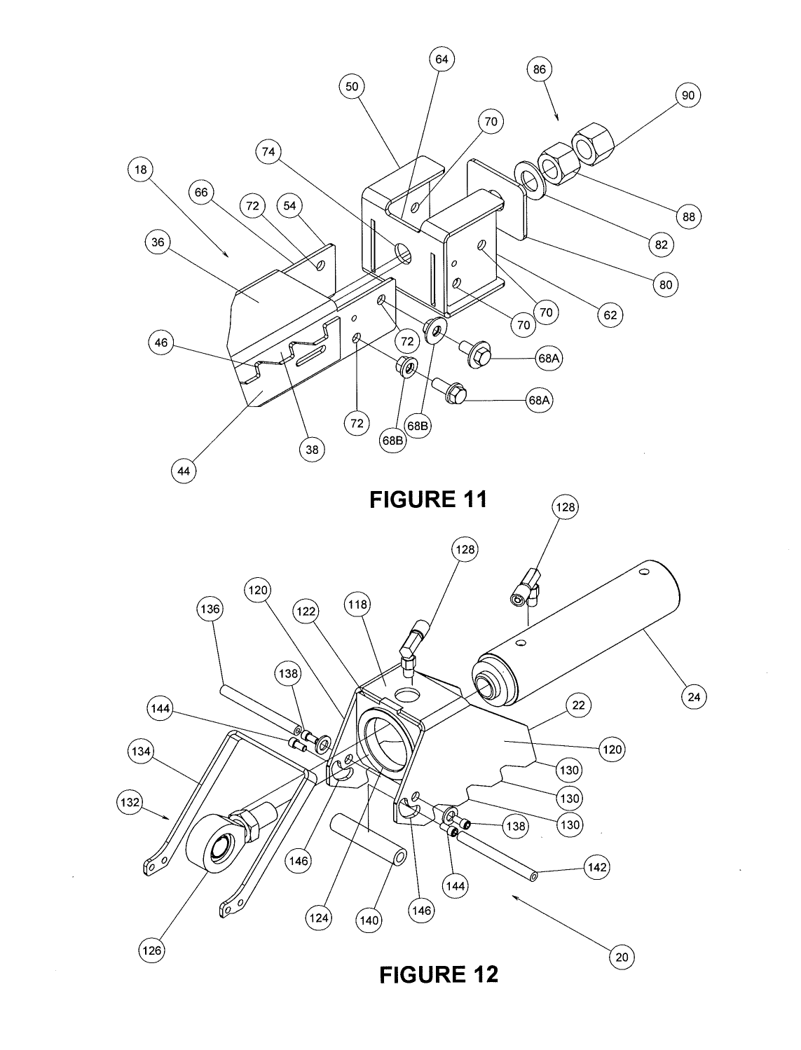

Frame 18 is mounted on support 32 by means of end brackets 48 and 50. End bracket 48 is mounted on a first, outer end 52 of frame 18 distal from the direction of travel of belt 34 and end bracket 50 is mounted on a second, inner end 54 of frame 18 proximal to the direction of travel of belt 34. In particular, each bracket 48, 50 includes a bottom panel 56 having apertures 58 formed therein for receiving mounting bolts 60 (FIG. 3) to anchor brackets 48, 50 on support 32. Each bracket 48, 50 also includes side panels 62 and a slotted end panel 64 extending between side panels 62. Side panels 62 are secured to mounting flanges 66, which extend at the ends of side surfaces 38 of frame 18, by means of fasteners 68A and 68B. As shown best in FIG. 11, fasteners 68A, 68B pass through apertures 70 and 72 which are formed in side panels 62 and mounting flanges 66 respectively.

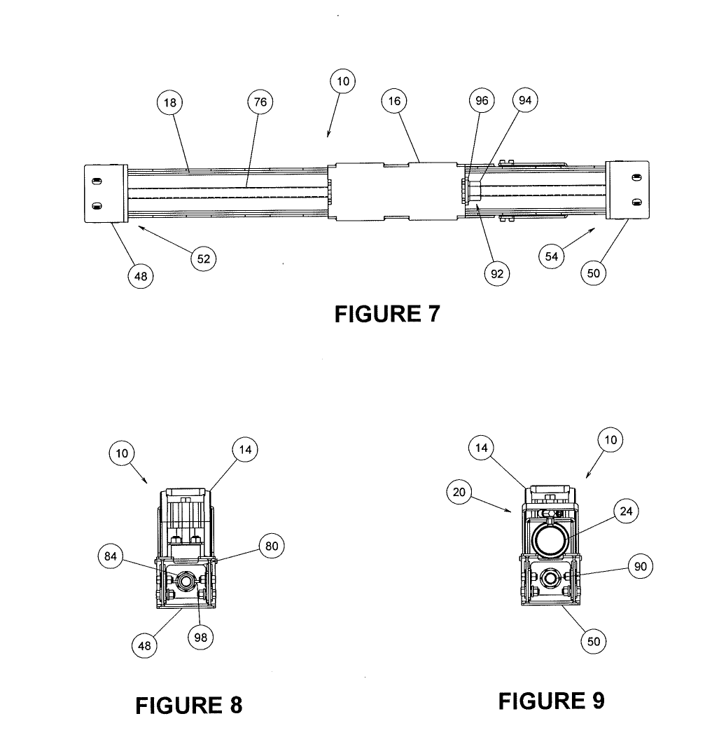

Each end panel 64 includes an aperture 74 for receiving an elongated, threaded screw 76 which extends lengthwise underneath upper surface 36 of frame 18 between side surface 38 (FIGS. 7, 10 and 13). Since screw 76 extends underneath frame surface 36 it is shielded from dirt and other contaminants which may be present at the installation location. One end of screw 76 is mounted to end panel 64 of end bracket 48 at the first, outer end 52 of frame 18 by means of a fastening assembly 78 comprising a mounting plate 80, washer 82 and actuating nut 84. Actuating nut 84 is integral with screw 76 for actuating rotation thereof. The other end of screw 76 is similarly mounted to end panel 64 of end bracket 50 at the second, inner end 54 of frame 18 by means of a fastening assembly 86 comprising a mounting plate 80, washer 82, retaining nut 88 and jam nut 90. Retaining nut 88 secures screw 76 to end bracket 50 but allows rotation of screw 76. Locking nut 90 secures retaining nut 88 in place. In an alternative embodiment end brackets 48, 50 and fastening assemblies 78, 86 can be interchanged so that screw 76 extends in the opposite direction underneath frame surface 36. Thus depending upon the particular configuration, selected screw 76 could be actuated from either end of frame 18.

As described further below, a locking locking nut 92 is mounted on screw 76 and is adjustable over the length thereof. As best shown in FIGS. 7, 10 and 13, locking nut 92 comprises an internally threaded nut portion 94 mounted on a plate 96. Plate 96 is sized so that its upper edge is located immediately adjacent the underside of frame surface 36. When screw 76 is rotated by turning actuating nut 84, the upper edge of plate 96 contacts frame surface 36 to stop nut portion 94 from turning with screw 76. As screw 76 continues to be rotated, locking nut 92 travels relative to frame 18 toward either outer end 52 or inner end 54 thereof, depending upon the direction of rotation, until locking nut 92 is adjusted to the desired position. Once the desired position is arrived at, a removable screw restraint pin 98 may be inserted through an aperture formed in actuating nut 84 to restrain any further rotation thereof. This prevents rotation of screw 76, for example due to vibration of take-up apparatus 10 at the installation location.

FIG. 10 shows slider assembly 12 in an exploded view. Slider assembly 12 comprises an upper bearing pedestal 14 and a lower slider housing 16. As will be apparent to a person skilled in the art, bearing pedestal 14 is configured for engaging pulley shaft 30 (FIG. 3) and houses bearings (not shown) within its internal connecting sleeve. Slider housing 16 is configured for sliding movement on frame 18. As best shown in FIG. 10, housing 16 includes an upper surface 100, opposed side surface 102 and an end plate 104 extending between side surfaces 102. End plate 104 includes an aperture 106 for passage of screw 76 therethrough. As described below, locking nut 92 may be secured to end plate 106 for locking slider housing 16 at a desired adjustment position along the length of frame 18 between first and second ends 52, 54 thereof. In the illustrated embodiment, bearing pedestal 14 has mounting flanges 108 having apertures 110 formed therein which receive screws 112 projecting upwardly from housing upper surface 100 and which may be secured using nuts 114. At one end of slider assembly 12 nearest second end 54 of frame 18 a pair of mounting rings 116 project upwardly from upper surface 100 for releasably coupling slider assembly 12 to push assembly 20 as described further below.

Push assembly 20 includes cylinder support housing 22 for supporting hydraulic cylinder 24. As shown best in FIG. 12, cylinder support housing 22 includes an upper surface 118, a pair of opposed side surfaces 120 and an end surface 122 extending transversely between side surfaces 120. End surface 122 has a threaded aperture 124 formed therein for threadedly receiving an end portion of cylinder 24. As indicated above, cylinder 24 includes an extensible piston rod 26 (FIG. 2) having an end which is releasably coupled to slider assembly 12 by means of a fitting 126 connectable to mounting rings 116 by means of a connecting pin 117 (FIG. 10). As shown best in FIG. 12, fitting 126 is threadedly coupled to an end of piston rod 26.

Cylinder 24 includes a pair of quick-connect hydraulic fluid supply fittings 128 for connecting cylinder 24 to a hydraulic pump unit (not shown). As will be apparent to a person skilled in the art, piston 26 can be controllably extended and retracted by adjusting the hydraulic pump unit controls.

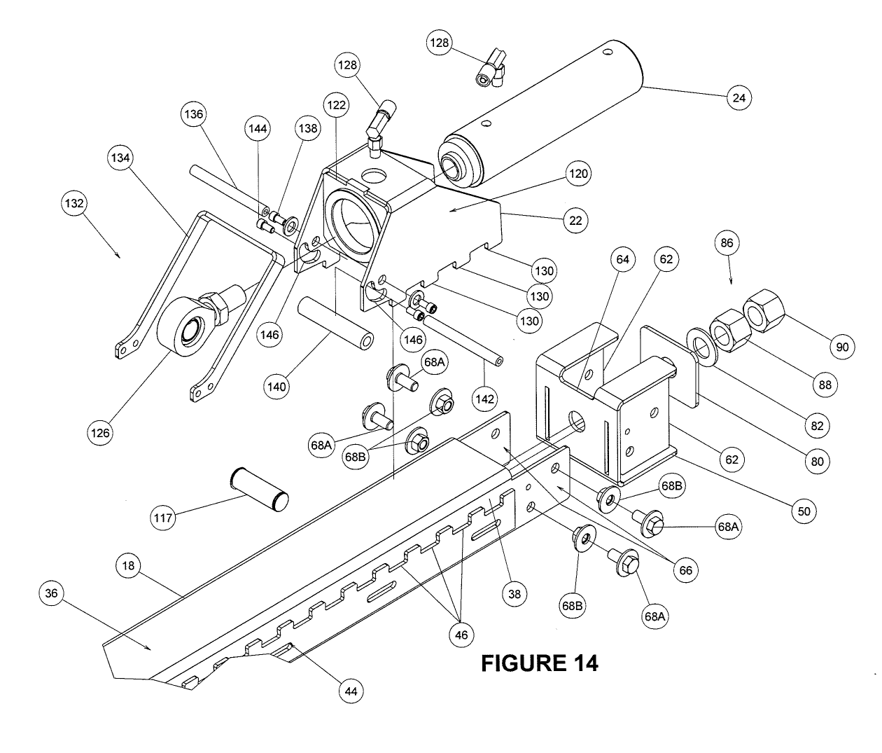

The lower edges of housing side surfaces 120 comprise a plurality of ratchet teeth 130 for engaging ratchet grooves 46 formed on side rails 40 of frame 18. As described below, ratchet teeth 130 enable push assembly 20 to be fixedly coupled to frame 18 at a selected longitudinal position. As will be apparent to a person skilled in the art, the mating ratchet teeth 130 and grooves 46 may be different shapes in alternative embodiments. For example, as shown in FIG. 14, the ratchet teeth/grooves may be castellated rather cam-shaped for secure engagement therebetween. Further, other means may also be substituted for the ratchet arrangement for mechanically coupling push assembly 20 to frame 18 at the desired position.

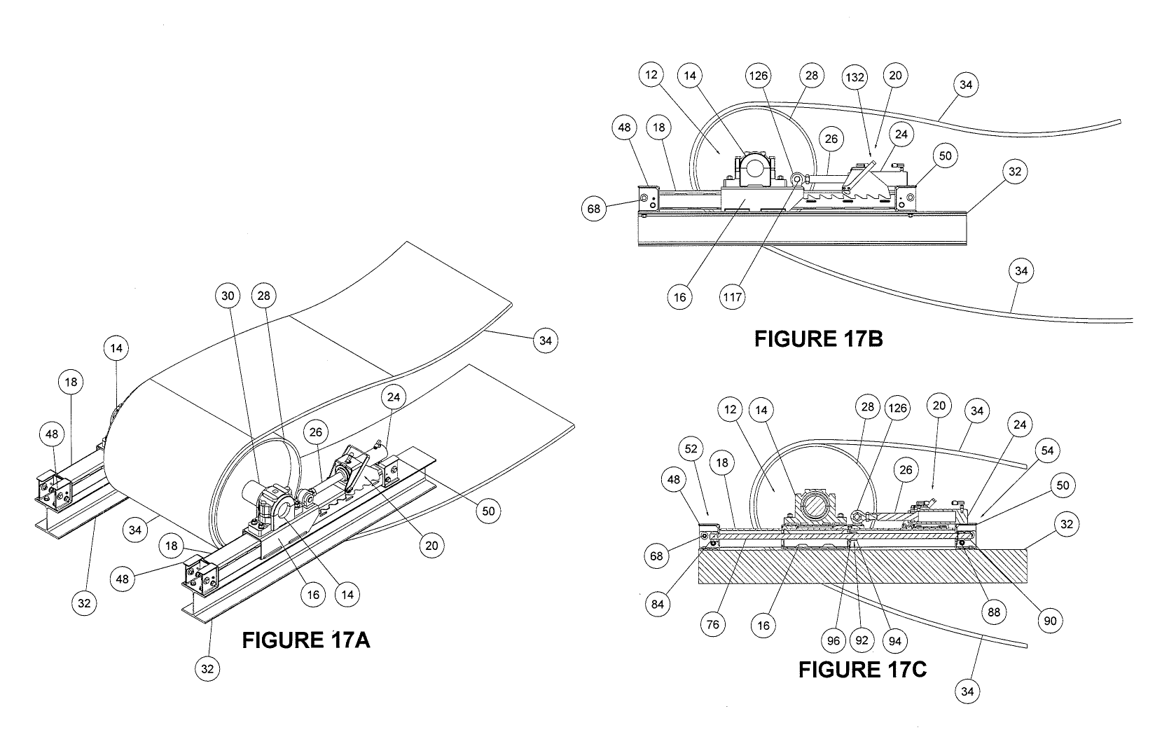

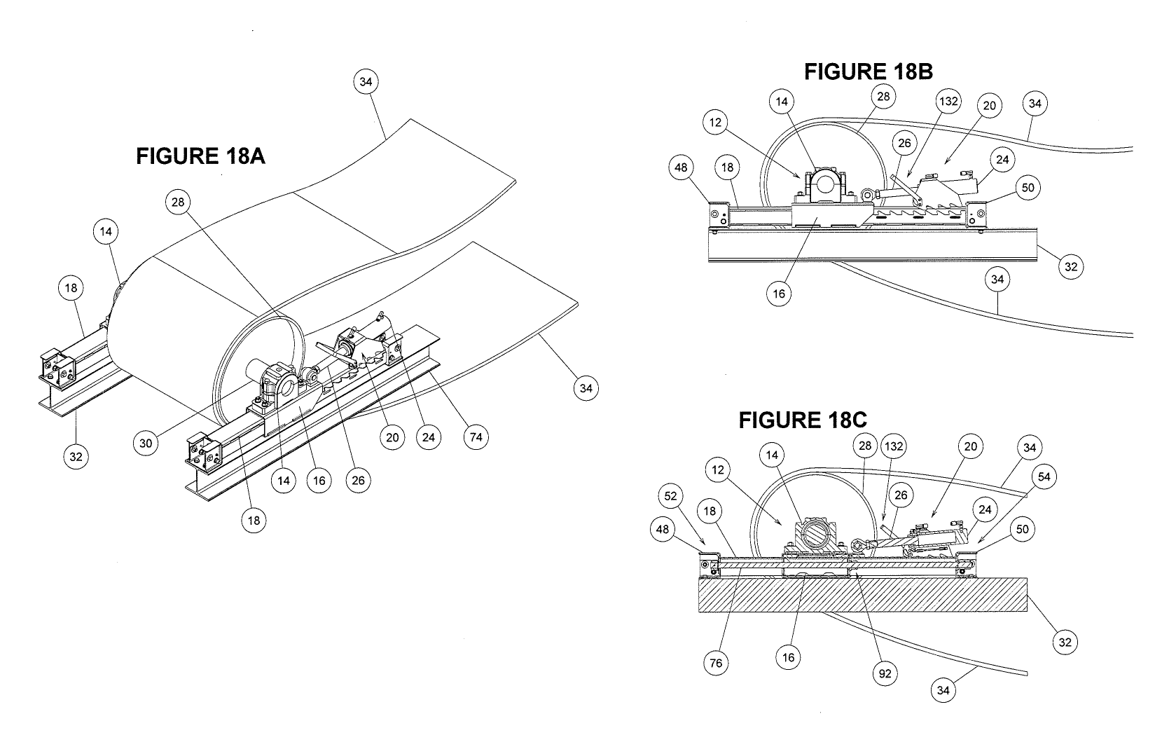

Push assembly 20 also includes a handle 132 that is pivotably coupled to a lower end portion of opposed side surfaces 120. Handle 132 comprises a U-shaped lever arm 134 coupled to housing 22 by a first elongate connecting pin 136. Fasteners 138 secure end portions of pin 136 to respective side surfaces 120. A roller 140 extends between the free ends of handle 132 and is coupled thereto by means of a second elongate connecting pin 142 which extends through the interior of roller 140 and is secured at either end by fasteners 144. End portions of pin 142 are movable within kidney-shaped slots 146 formed in opposed lower portions of housing side surfaces 120. As handle 132 is pivoted from a raised (FIGS. 17A-17C) to a lowered (FIG. 18A-18C) position, the end portions of pin 142 move downwardly in respective slots 146 to bring roller 140 in contact with the upper surface 36 of frame 18. Pivoting motion of handle 132 between the raised and lowered positions enables adjustment of push assembly 20 from a locked position where ratchet teeth 130 engage grooves 46 on side rails 40 (FIGS. 17A-17C) to an unlocked position where ratchet teeth 130 are disengaged from grooves 43 and roller 140 contacts upper surface 36 of frame 18 for rolling movement thereon (FIGS. 18A-18C).

In operation, a pair of apparatuses 10 are positioned on opposite sides of a pulley cylinder 28 for adjusting the tension of a conveyor belt 34 travelling thereon. (FIG. 2). In the following description the adjustment steps will be described in respect of a single apparatus 10, but it will be understood by a person skilled in the art that the same or similar adjustment steps occur in the other apparatus 10.

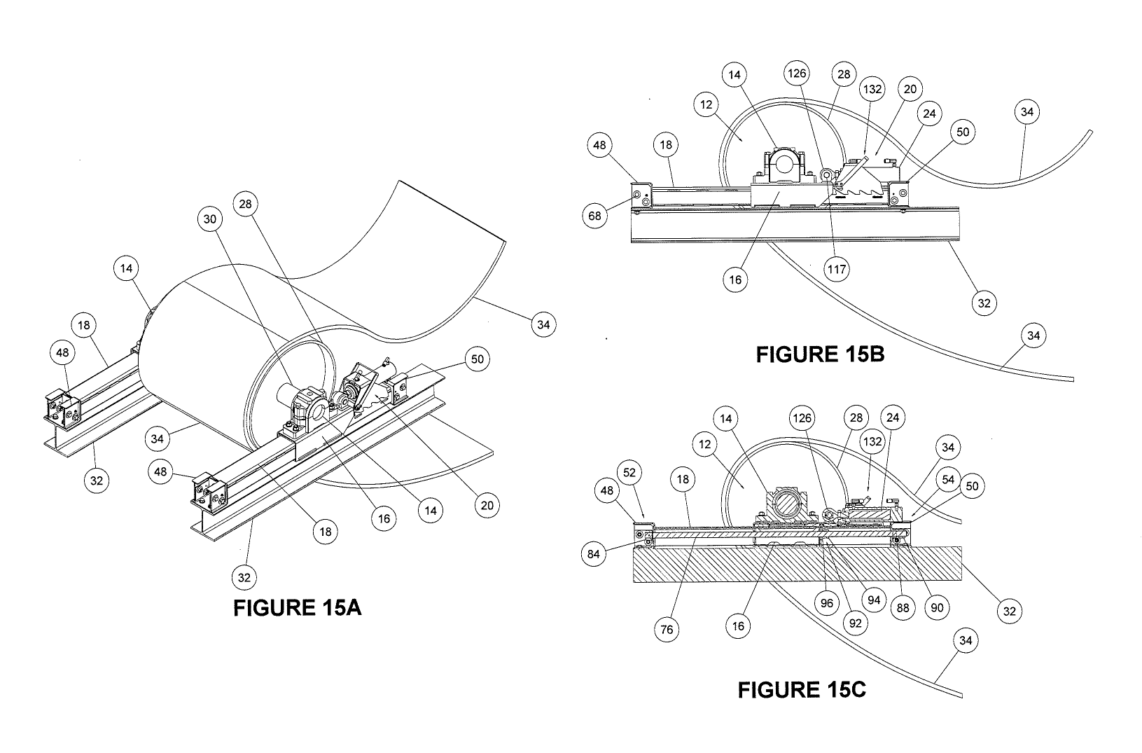

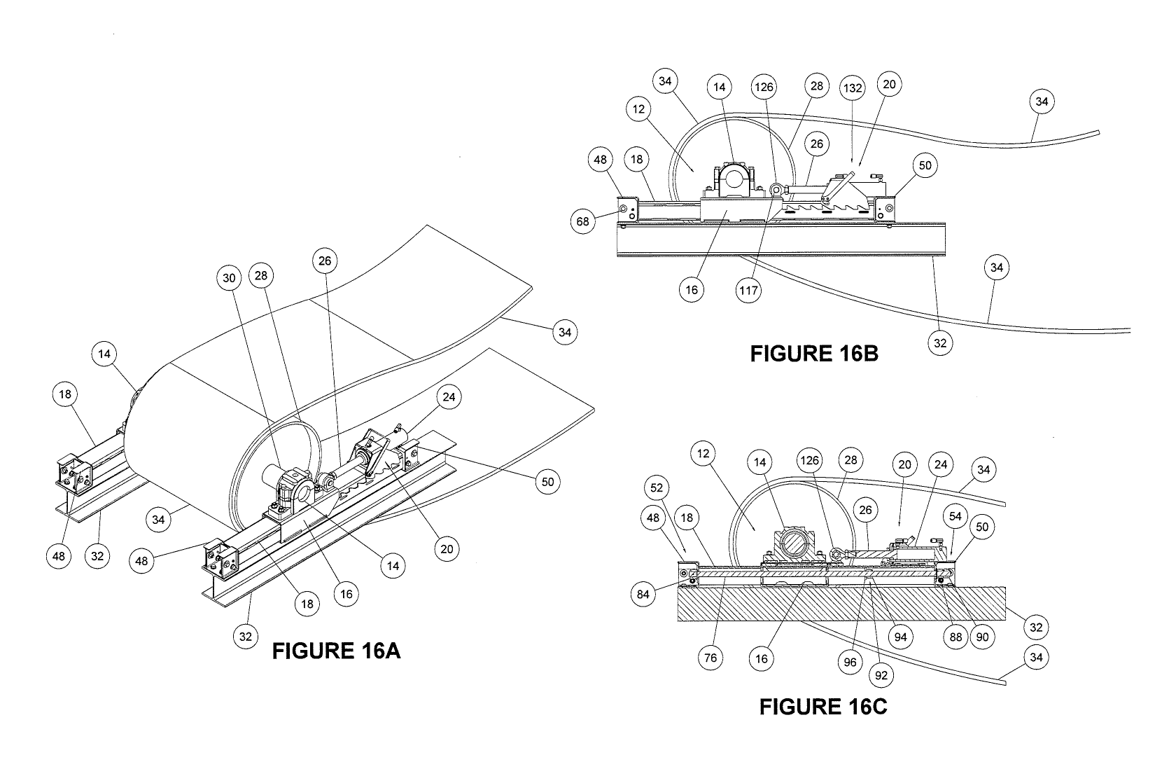

FIGS. 15A-15C show apparatus 10 deployed in an initial position for installing a new belt 34. In this initial position, push assembly 20 is fixed to frame 18 by means of engagement between ratchet teeth 130 and mating grooves 46 on side rails 40. As shown in FIG. 15C, locking nut 92 is secured tightly against slider assembly 12. As shown in FIGS. 16A-16C, the first step in the adjustment sequence is to extend piston 26 of cylinder 24 by means of hydraulic pump controls to cause slider assembly 12 and attached pulley cylinder 28 to move toward anchor bracket 48 mounted at outer end 52 of frame 18. More particularly, the pressure and return hoses from the hydraulic pump unit (not shown) are coupled to the quick-connect hydraulic fluid supply fittings 128 on cylinder 24. In the case of initial installation, the pressure relief valve on the hydraulic pump can be set at a relatively low pressure (e.g. 2000 psi). Cylinder 24 is actuated to move piston rod 26 out to full stroke to cause displacement of slider assembly 12 and attached pulley cylinder 28. Movement of cylinder 28 outwardly in a direction opposite to the direction of travel of belt 34 causes tightening of belt 34. As shown best in FIG. 16C, locking nut 92 remains in its initial position, now spaced apart from slider assembly 12.

In the next step in the adjustment sequence locking nut 92 is secured to slider assembly 12 by rotating screw 76 (FIG. 17C). Screw 76 can be rotated either manually using a wrench or by using a hydraulic wrench or other power tool coupled to actuating nut 84. Securement of locking nut 92 to slider assembly 12 causes assembly 12 to be mechanically locked to frame 18.

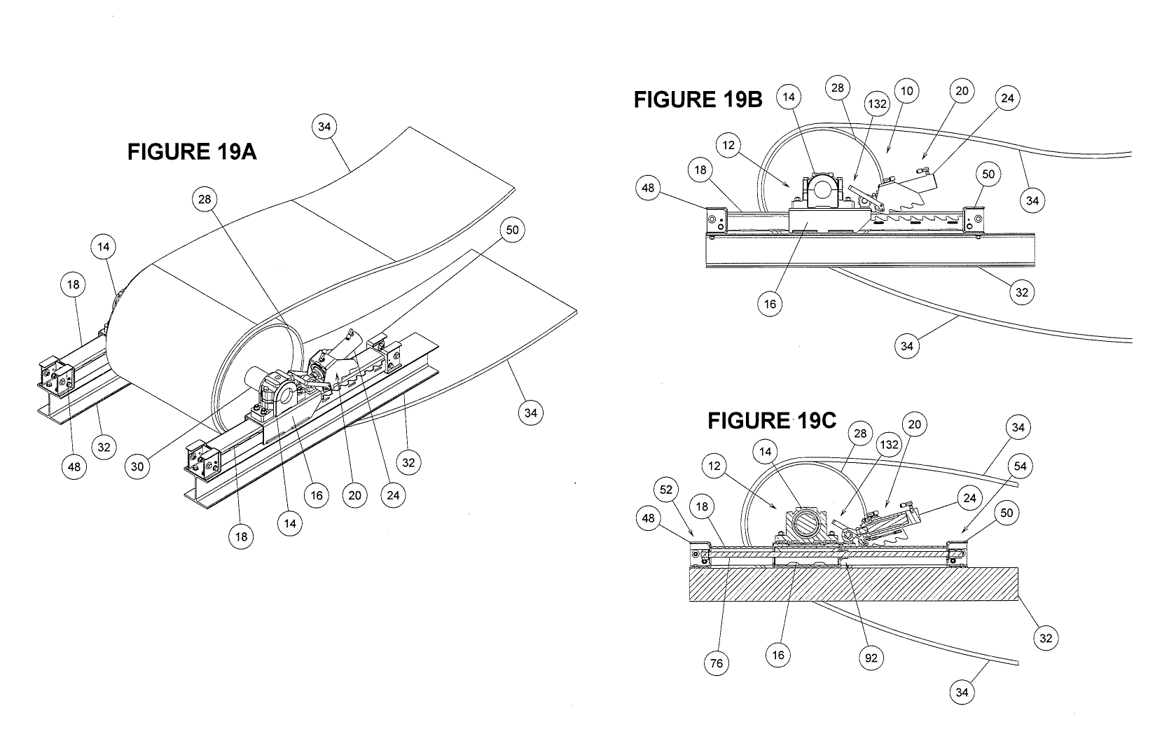

In the next step in the adjustment sequence shown in FIGS. 18A-18C, assuming further tightening of belt 12 is required, push assembly 20 is disengaged from frame 18 by moving handle 132 from the raised to the lowered position (FIGS. 17B and 18B). As explained above, this moves roller 140 into contact with upper surface 36 of frame 18 for rolling movement thereon and causes ratchet teeth 130 to disengage from grooves 46 on side rails 40, as shown best in FIGS. 19A-19C. At the same time, the hydraulic fluid pumping direction may be reversed by adjusting the solenoid or hand valve on the hydraulic pump unit to move piston rod 26 from the extended to the retracted position.

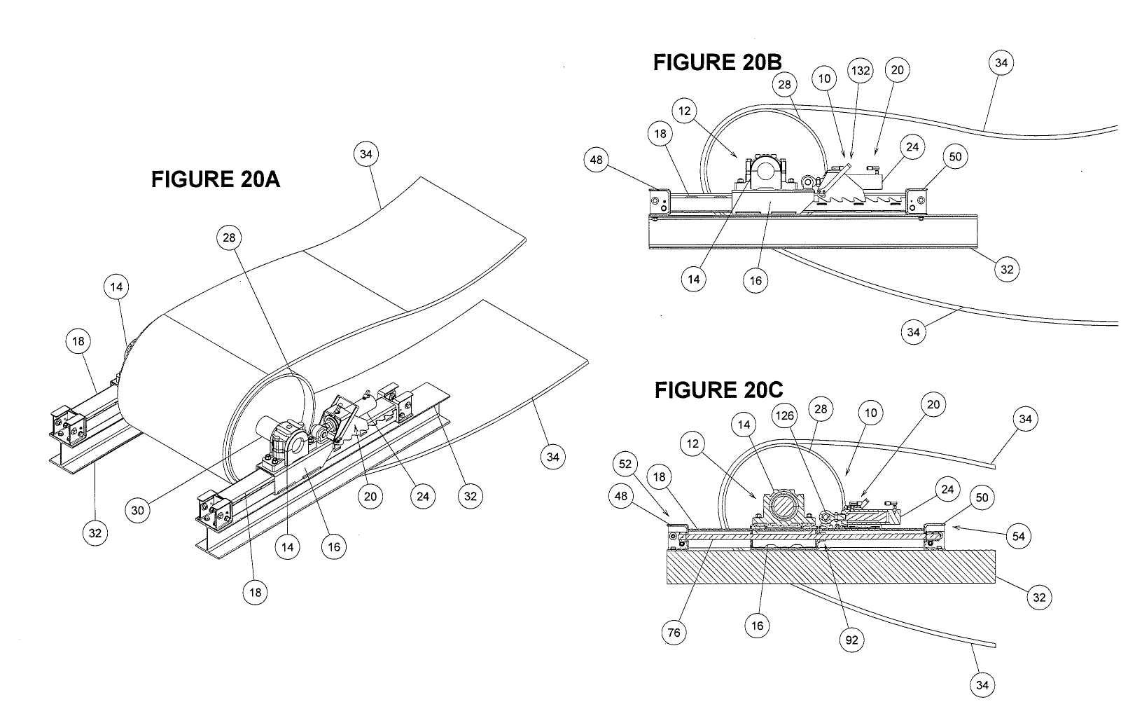

In the next step in the adjustment sequence shown in FIGS. 20A-20C, push assembly 20 is lowered into fixed engagement with frame 18 immediately adjacent to slider assembly 12 by pivoting handle 132 from the lowered to the raised position and inserting ratchet teeth 130 into grooves 46 of side rails 40. Apparatus 10 is now in a configuration similar to the initial configuration of FIGS. 15A-15C except that it is displaced at a location closer to outer end 52 of frame 18 adjacent to slider assembly 12.

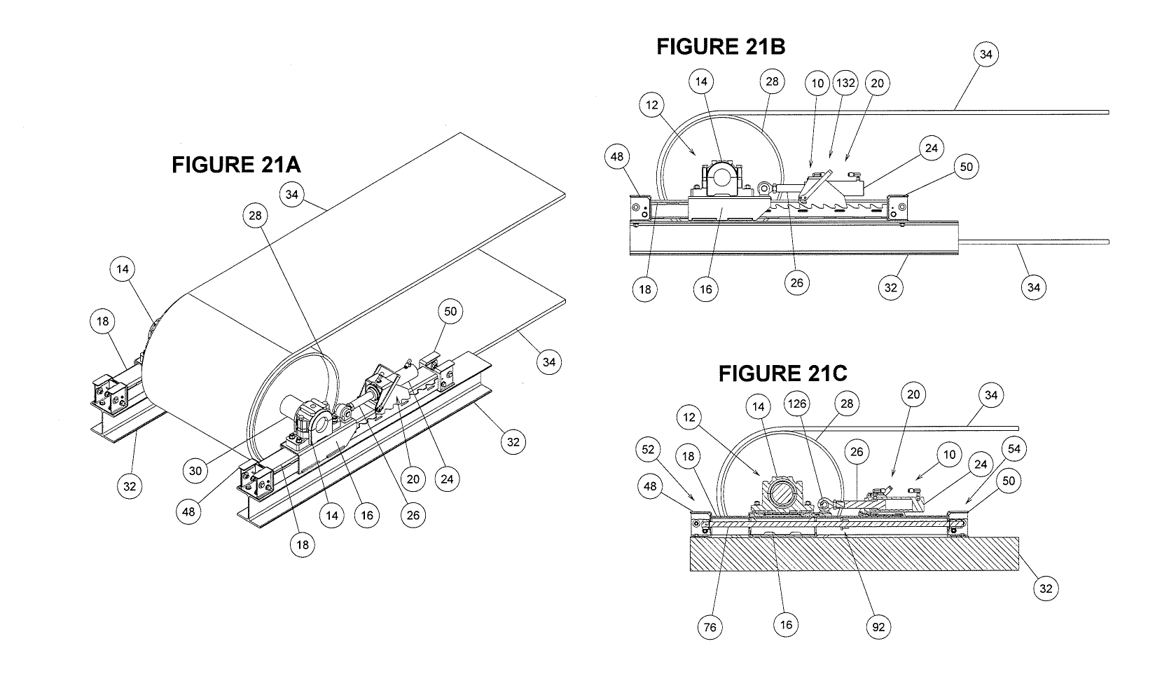

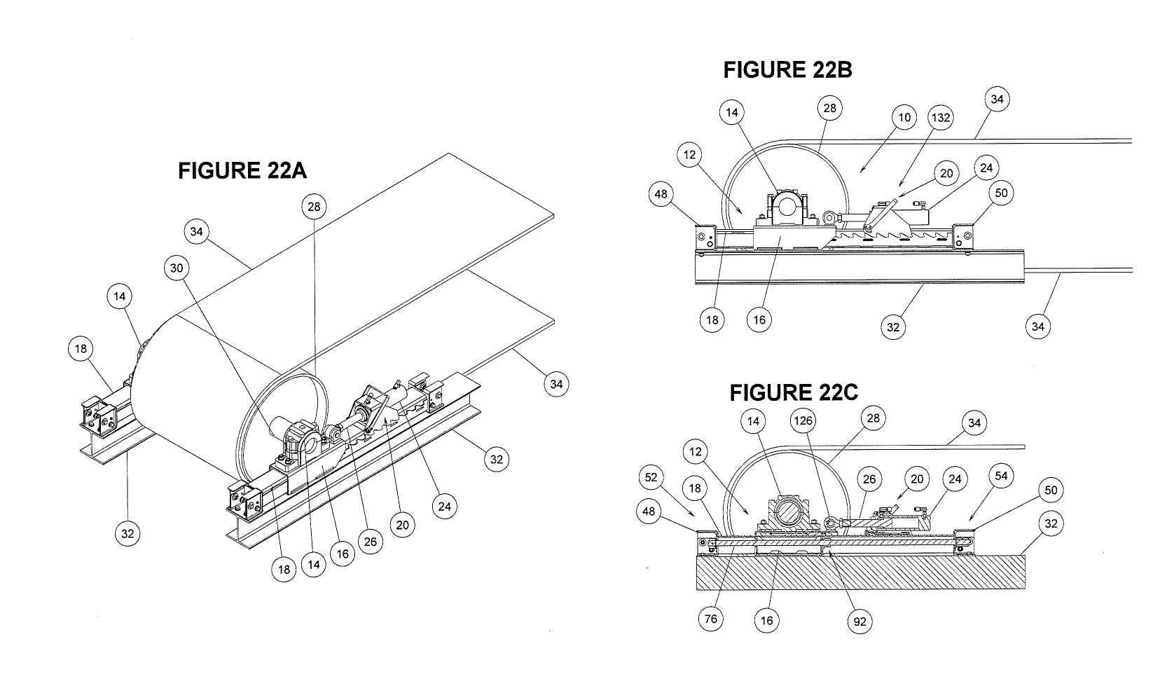

In the next step in the adjustment sequence shown in FIGS. 21A-21C, the pumping direction of the hydraulic pump unit is reversed and piston rod 26 of cylinder 24 is once again extended to cause slider assembly 12 and attached cylinder 28 to move further toward outer end 52 of frame 18. Such further movement of cylinder 28 outwardly in a direction opposite to the direction of travel of belt 34 causes final tightening of belt 34 to the desired tension. Once it is apparent that belt 34 is tightening, the pressure setting on the hydraulic pump unit can be increased to the desired final setting required for proper belt tension. As will be apparent to person skilled in the art, the force required to achieve the desired setting will vary depending on the circumstances. If the tightening of belt 34 is intended to be dynamic, locking nut 92 can remain in the position shown in FIG. 21C spaced-apart from slider assembly 12. In this case cylinder 24 will provide the required force by means of the pre-set hydraulic pressure and hence bearing pedestal 14 coupled to pulley shaft 30 will essentially “float”. Optionally, if the tightening of belt 34 is intended to be static, then the final step in the adjustment sequence can be undertaken as shown in FIGS. 22A-22C. In particular, locking nut 92 may be secured to slider assembly 12 by rotating screw 76 (FIG. 22C). Securement of locking nut 92 to slider assembly 12 causes assembly 12 to be mechanically locked to frame 18 in the final position. Screw restraint pin 98 may then be inserted through actuating nut 84 to restrict any further rotation of screw 76 (FIG. 10).

If push assembly 20 needs to be deployed in another conveyor system take-up apparatus 10, or if maintenance personnel wish to avoid any potential damage to push assembly 20, it may be detached from slider assembly 12 by removing connecting pin 117 and removed from the remainder of apparatus 10 (FIG. 10).

The steps required to adjust the tension of a pre-installed belt 34 with take-up apparatus 10 are the same as described above except the travel distance is shorter than in an initial installation since there is typically no slack in belt 34.

In order to release tension and slacken belt 34, some of the adjustment steps described above would be reversed. For example, cylinder 24 could be actuated to extend hydraulic piston rod 26 to a setting operable to assume the load of belt 34 in full tension, i.e. until slider assembly 12 exerts no load on locking nut 92. Locking nut 92 could then be loosened and backed-off in a direction toward push assembly 20. Cylinder 24 could then be adjusted to retract piston rod 26. The retraction of piston rod 26 and release of tension in belt 34 will causes slider assembly 12 to move on frame 18 toward push assembly 20, thereby slackening belt 34. If necessary, push assembly 20 could then be moved further toward inner end 54 of frame 18 as described above and fixed in place at another selected location on frame 18. The process could then be repeated to further slacken belt 34 to the extent desired.

As will be apparent to a person skilled in the art, the specific sequence and iterations of the adjustment steps described above will vary depending upon the circumstances. If the required travel distance of pulley cylinder 28 is relatively small to make the necessary adjustment to the tension of belt 34, then it may only be necessary to extend piston rod 26 of cylinder 24 once to achieve the required displacement of slider assembly 12. For example, as indicated above, periodic maintenance adjustments may have a much smaller travel distance than initial installment adjustments of belt 34. Conversely, in the case of very long travel distances, two or more iterations of adjustments may be required to achieve the desired travel distance. Since initial installation and maintenance of conveyor belts 34 are usually infrequent, the operator time required to complete a belt adjustment is not a significant factor. Also, since a single, short-stroke cylinder 24 may be used over a wide range of travel distances it is not necessary to maintain an inventory of hydraulic cylinders of different sizes and pressure ratings. This helps achieve parts commonality and economies of scale.

Thus apparatus 10 is sufficiently versatile to cover a wide range of travel distances while maintaining a very compact design. As indicated above, the compact footprint of apparatus 10 has an important safety advantage. Since cylinder 24 does not extend beyond inner end 54 of frame 18 it is less likely to pose a tripping or other safety hazard to personnel working in or around pulley cylinder 28 as compared to the prior art take-up apparatus 2 of FIG. 1.

In one embodiment cylinder 24 may be a short-stroke (9 inch) hydraulic cylinder manufactured for an operating pressure of 10,000 psi. The combination of a high working pressure and compression only operation during the belt tightening process enables the use of a cylinder 24 having a relative small diameter. Further, the use of a short stroke and small diameter cylinder 24 enables the use of small hydraulic pump units. This may be especially important when electric power is unavailable at the installation site. In such circumstances a manual pump may be used as only small amounts of oil need to be displaced and hence comparatively little energy is required to actuate cylinder 24.

As will be appreciated by a person skilled in the art, the stroke distance, cylinder diameter, pressure rating and other operating parameters may vary in alternative embodiments. By way of non-limiting examples, the following models could be configured in exemplary embodiments:

10,000 lbs. (45.5 kN) covering SAF bearing units for shaft sizes between 2 7/16″ and 3 7/16″ (60 mm and 90 mm) operated by 2½″×9″ stroke, 10,000 psi jack cylinder.
20,000 lbs. (91 kN) covering SAF bearing units for shaft sizes between 3 15/16″ and 4 15/16″ (100 mm and 130 mm) operated by 3″×9″ stroke, 10,000 psi jack cylinder.
40,000 lbs. (182 kN) covering SAF and SD bearing units for shaft sizes between 4 15/16″ and 7⅞″ (125 mm and 200 mm) operated by 3″×9″ stroke, 10,000 psi jack cylinder.
75,000 lbs. (340 kN) covering SAF and SD bearing units for shaft sizes between 6 7/16″ and 11.024″ (160 mm and 280 mm) operated by 5″×9″ stroke, 10,000 psi jack cylinder.
120,000 lbs. (544 kN) covering SD bearing units for shaft sizes between 11.811″ and 14.173″ (300 mm and 360 mm) operated by 5″×9″ stroke, 10,000 psi jack cylinder.
All models could be supplied with travel lengths of 24″ (610 mm), 30″ (762 mm), 36″ (915 mm), 48″ (1219 mm) and 60″ 1524 mm)

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A conveyor take-up apparatus comprising:
(a) an elongated frame positionable adjacent to a pulley cylinder supporting travel of a conveyor belt:
(b) a slider assembly configured for travel on said frame, wherein slider assembly comprises a bearing pedestal for coupling to a shaft of said pulley cylinder;
(c) a locking assembly for releasably locking said slider assembly to said frame at an adjustment position; and
(d) a push assembly for applying a force to said slider assembly, wherein said push assembly comprises:
(i) a cylinder support housing movable on said frame and releasably connectable thereto at a selected location along the length of said frame; and
(ii) a hydraulic cylinder mounted on said support housing, said cylinder having an end coupled to said slider assembly.

2. The apparatus as defined in claim 1, wherein said cylinder support housing is adjustable between an engaged position fixably coupled to said frame at said selected location and a disengaged position permitting movement of said support housing relative to said frame.

3. The apparatus as defined in claim 1, wherein said cylinder support housing is ratchedly coupled to said frame.

4. The apparatus as defined in claim 1, wherein said frame comprises first and second side rails located on opposite sides of said frame, wherein each of said rails comprises a plurality of ratchet grooves, and wherein an undersurface of said support housing comprises a plurality of ratchet teeth for engaging said ratchet grooves at selected positions on said rails to fixedly couple said support housing to said frame.

5. The apparatus as defined in claim 4, wherein each of said first and second rails comprise a first portion having a flat upper edge for travel of said slider assembly thereon and a second portion comprising said ratchet grooves for engagement with said cylinder support housing.

6. The apparatus as defined in claim 5, wherein said ratchet grooves are located at one end of each of said first and second rails.

7. The apparatus as defined in claim 4, wherein said ratchet teeth and grooves are castellated.

8. The apparatus as defined in claim 2, wherein said cylinder support housing is adapted for rolling movement on an upper surface of said frame when said housing in said disengaged position.

9. The apparatus as defined in claim 8, further comprising a lever for pivotably adjusting said support housing between said engaged and disengaged positions.

10. The apparatus as defined in claim 9, wherein said lever comprises a handle pivotably coupled to side panels of said support housing.

11. The apparatus as defined in claim 10, wherein said handle is operable for lifting at least part of said support housing clear of said frame for adjusting the position of said support housing relative to said frame in said disengaged position.

12. The apparatus as defined in claim 1, wherein said locking assembly comprises:
(a) an elongated screw extending lengthwise underneath an upper surface of said frame and having end portions coupled to said frame, wherein said slider assembly comprises an aperture to enable passage of said screw therethrough; and
(b) a locking nut rotatably mounted on said screw for locking said slider assembly on said screw at an adjustment position.

13. The apparatus as defined in claim 12, wherein said locking assembly further comprises a screw restraint pin for releasably constraining rotation of said screw.

14. The apparatus as defined in claim 1, wherein said cylinder does not extend beyond the length of said frame.

15. The apparatus as defined in claim 1, wherein said cylinder is a short-stroke cylinder having a travel distance of less than 10 inches.

16. The apparatus as defined in claim 1, wherein the take-up length of said belt is within the range of 24 to 60 inches.

17. The apparatus as defined in claim 1, wherein said cylinder operates solely in compression when operable to move said slider assembly to increase the tension of said conveyor belt.

18. The apparatus as defined in claim 1, wherein said cylinder comprises an adjustable piston rod having an end which is detachably coupled to said slider assembly.

19. The apparatus as defined in claim 12, wherein said locking assembly is adjustable between a locked position wherein said locking nut contacts said slider assembly and an unlocked position wherein said locking nut is displaced on said screw at a position spaced apart from said slider assembly.

20. A method of adjusting the tension of a conveyor belt travelling on a pulley cylinder having a pulley shaft, said method comprising:
(a) providing a take-up apparatus as defined in claim 1;
(b) coupling said bushing pedestal of said slider assembly to said pulley shaft;
(c) engaging said cylinder support housing at a first selected location on said frame;
(d) adjusting said locking assembly to an unlocked position;
(e) actuating said hydraulic cylinder of said pusher assembly to move said slider assembly on said frame in a direction away from said pusher assembly toward a first end of said frame, thereby tightening said belt; and
(f) adjusting said locking assembly to a locked position.

21. The method as defined in claim 20, further comprising:
(g) disengaging said cylinder housing from said frame and moving said housing toward said first end to a second selected location on said frame closer to said slider assembly while retracting said cylinder piston;
(h) fixedly engaging said support housing on said frame at said second selected position;
(i) adjusting said locking assembly to an unlocked position; and
(j) actuating said hydraulic cylinder of said pusher assembly to further move said slider assembly on said frame in a direction away from said pusher assembly toward said first end of said frame, thereby further tightening said belt.

22. The method as defined in claim 21, further comprising adjusting said locking assembly to a locked position.

23. The method as defined in claim 22, further comprising detaching said push assembly from said slider assembly and said frame.
